(19) United States
(12) Patent Application Publication
(10) Pub. No.: US 2005/0273815 A1
(43) Pub. Date: Dec. 8, 2005

(54) Method and apparatus for the display of electronic program guide information

(75) Inventors: Stephen J. Orr, Markham (CA); Anton Komar, Toronto (CA)

Correspondence Address: ATI TECHNOLOGIES, INC.;C/O VEDDER PRICE KAUFMAN & KAMMHOLZ, P.C., 222 N.LASALLE STREET, CHICAGO, IL, 60601, US

(73) Assignee: ATI Technologies Inc., Markham (CA)

(21) Appl. No.: 10/861,605

(22) Filed: Jun. 4, 2004

(51) Int. Cl. H04N 7/16; H04N 5/445

(52) U.S. Cl. 725/45; 725/46; 725/52

(57) ABSTRACT

A method and apparatus for the display of electronic program guide information includes receiving a plurality of viewing event indicators indicating a plurality of viewing events. The viewing event indicators may be any suitable data representation of the corresponding viewing event, such as a multi-digit program identifier and a program title, such as the name of the television show. The method and apparatus further includes generating a first list of viewing event indicators based on a viewing start time and a second list of viewing event indicators from the first list of viewing event indicators based on the viewing events having common elements within the viewing event indicators. The method and apparatus further includes providing the second list to a display device so the electronic program guide information includes timely viewing event indicators and excludes redundant viewing event indicators.

### FIELD OF THE INVENTION

The present invention relates generally to electronic program guides and more specifically to the combining and display of electronic program guide information.

### BACKGROUND OF THE INVENTION

Existing television viewing systems including electronic program guide information typically based on a grid system. A typical television broadcast includes data representing three individual data fields. The first data field is a channel lineup which defines all of the specific channels available for viewing. The second data field is a show lineup which includes all of the data relating to the individual shows being displayed. The third element is a schedule which coordinates when a particular viewing event from the show lineup is available for viewing.

In a typical electronic programming guide display system, the show lineup data represents the available viewing event indicators, the specific television broadcast show or episode. For example, a typical television episode may be an episode of the sitcom Friends and a recurring show may be the 6 O'clock Evening News. Each of the viewing event indicators may be associated with a representative multi-digit number. Further associated with the number are index coordinates associated with a particular viewing grid. A processing device, such as a television set top box, when enabled by an end user creates a rectangular grid including time along the X axis and viewing channels along the Y axis.

FIG. 1 illustrates a graphical representation of the existing electronic program guide display 100. The display 100 includes time on the X axis 102 and channels on the Y axis 104. Populated within the grid are the coordinated television shows. Using the existing electronic program guide information, the processor generates the grid display of the electronic program guide.

The display 100 illustrates four hours of television programming on seven different channels. In a typical viewing system, there are hundreds of available channels with multiple days of programming information readily available. Therefore, the current grid-based electronic program guide system creates a veritable information-overload for a user to determine a viewing list. Based on the information overload, modern systems allow users to easily overlook viewing event indicators. This may be especially true for seasonal content broadcast only once per year, for example, a particular sporting event.

Current systems allow a user to limit the number of channels on the grid-based display by using a favorites listing of channels. While this approach reduces the number of channels on the Y axis 104, the grid-based approach still provides a large amount of viewing information within a small area. Moreover, limiting channel-specific displays, such as a favorite channel list, does not allow the user to eliminate undesired content, but rather eliminates all content on unwanted channels.

Further advances with electronic program guides allow for further information to be provided within the show lineup data fields. For example, a viewing event is typically labeled with a common name such that a viewer may actively recognize the name of the viewing event, for example, an episode of Friends. Further included may be information describing the plot of the episode, actor information, season and/or episode information, if the show is a new episode or a rerun, or any other programming guide information.

In existing prior art grid based electronic program guide systems, limitations also exist regarding filtering of information. When a list of viewing events is filtered, the grid-based system would produce a grid having blank spaces, without effectively reducing the total amount of viewing area. Another filter approach is the elimination of specific channels, but this may be problematic for channels have varied programming, for example a national broadcaster may broadcast talks shows, news shows, sporting events, game shows and sitcoms during a viewing time period. So a user wishing to filtering channels would be limited to channels dedicated to a particular genre, e.g. a news channel, a sporting channel, or any other genre-specific channel.

Current programming guide information systems also allow for a user to search through available content. Searching features may be cumbersome based on ambiguities with regards to defined search characteristics. For example, different broadcasters may provide different descriptions of similar events, such as a world sports station describing a soccer event as football and a U.S. broadcast station also using the term football, but not directly referring to the sport of soccer.

Therefore, there exists a need for presenting electronic program guide information such that a user may quickly and automatically obtain pertinent viewing information.

### BRIEF DESCRIPTION OF THE DRAWINGS

FIG. 1 illustrates a graphical representation of a prior art grid-based electronic program guide display;

FIG. 2 illustrates a graphical representation of the combining of a program guide display list in accordance with one embodiment of the present invention;

FIG. 3 illustrates a schematic block diagram of an apparatus for display of electronic program guide information in accordance with one embodiment of the present invention;

FIG. 4 illustrates a graphical representation of navigational program guide display lists in accordance with one embodiment of the present invention;

FIG. 5 illustrates a graphical representation of sub-level display of filtered program guide information in accordance with one embodiment of the present invention;

FIG. 6 illustrates a flowchart of a method for the display of electronic program guide information;

FIG. 7 illustrates a graphical representation of a display of program guide information in accordance with one embodiment of the present invention; and

FIG. 8 illustrates a graphical representation of a display of program guide information in accordance with one embodiment of the present invention.

### DETAILED DESCRIPTION OF A PREFERRED EMBODIMENT

Briefly, the present invention includes a method and apparatus for the display of electronic program guide information. The method and apparatus includes receiving a plurality of viewing event indicators indicating a plurality of viewing events. The viewing event indicators may be any suitable data representation of the corresponding viewing event, such as but not limited to a multi-digit program identifier and a program title. The viewing event indicators may include further information, such as a specific information regarding the contents of the viewing event, such as the topic of discussion of a talk show.

The method and apparatus further includes generating a first list of viewing event indicators based on a viewing start time. A viewing start time indicates a selected viewing time, such as an hour and minute time, e.g. 10:00 a.m. Therefore, all of the viewing event indicators on the first list indicate viewing events occurring at a particular time, the viewing start time.

The method and apparatus further includes generating a second list of viewing event indicators from the first list of viewing event indicators based on the viewing events having common elements within the viewing event indicators. For example, if multiple channels carry the same viewing event, the second list will contain a single entry representative to the multiple broadcasts of the same show. The method and apparatus further includes providing the second list to a display device, such as any suitable output display. Therefore, when a user seeks to review an on-screen electronic program guide, the display device displays only the viewing event indicators representing viewing events having the same viewing start time and reducing redundant viewing event indicators within the program guide.

More specifically, FIG. 2 illustrates a graphical representation of the combining 120 of an original list 122 of viewing event indicators 124 at a particular time 126 to a condensed list of viewing event indicators 130 at the same time 126. The condensed list 130 includes a reduced number of viewing event indicators 132 or stated another way, a more efficient listing of pertinent viewing event indicators.

Through processing techniques, as described below, viewing event indicators having common elements may be combined. For example, in a first combining approach 134, multiple episodes of the talk show Oprah are listed in the first viewing events list 122 and are combined to a single listing in the second viewing events list 130. In a second combining approach 136, common news events may be combined based on the particular genre of news based broadcasts. As illustrated in FIG. 2, the combining 136 combines five news programs into a general listing of news in the second viewing events list 130.

A third combining approach also includes the combination of not only genre but also common broadcasts. The combining 138 filters multiple sporting events, in this exemplary embodiment baseball games, into a single listing of baseball 132 on the second viewing events list 130. The combining 138 further includes the combination of identical broadcasts of the Cubs vs. Mets baseball game. This broadcast may be duplicative based on reception of a broadcast out of a Chicago based station and a broadcast out of a New York based station. Although, the combining 138 combines these two broadcasts with all other similarly situated genre based broadcasts relating to baseball.

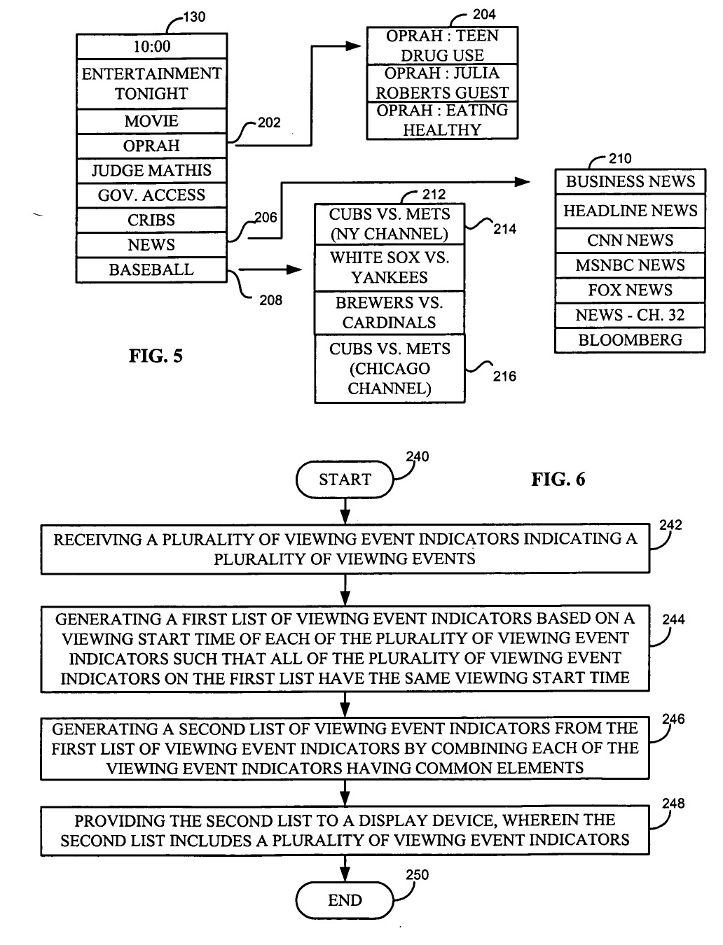

Therefore, using the present invention, as described in further detail below, an original programming list 122 of viewing event indicators 124 may be condensed, with viewing event indicators having common elements combined to generate the viewing event indicators list 130. Within the present invention, a user may then scroll through the available events and indicate that they want to view, for example, a baseball game. The user may select the baseball event indicator which can then expand to a second listing indicating all available baseball games, as described in further detail below with respect to FIG. 5.

In another embodiment, the present invention may further include filtering the programming information based on any suitable filtering approach. In the present invention, as the programming guide information is displayed to an end user independent of specific channels, i.e. broadcasters, each viewing event may be specifically analyzed for a filtering operation. Therefore, in one embodiment, the list of viewing event indicators 124 may be a previously filtered list. In one embodiment, filtering techniques as discussed in co-pending patent application Ser. No. XX/XXX,XXX having the title “METHOD AND APPARATUS FOR AUTOMATED DISPLAY OF VIDEO PROGRAMMING GUIDE INFORMATION” with the common assignee of the present invention, may be utilized.

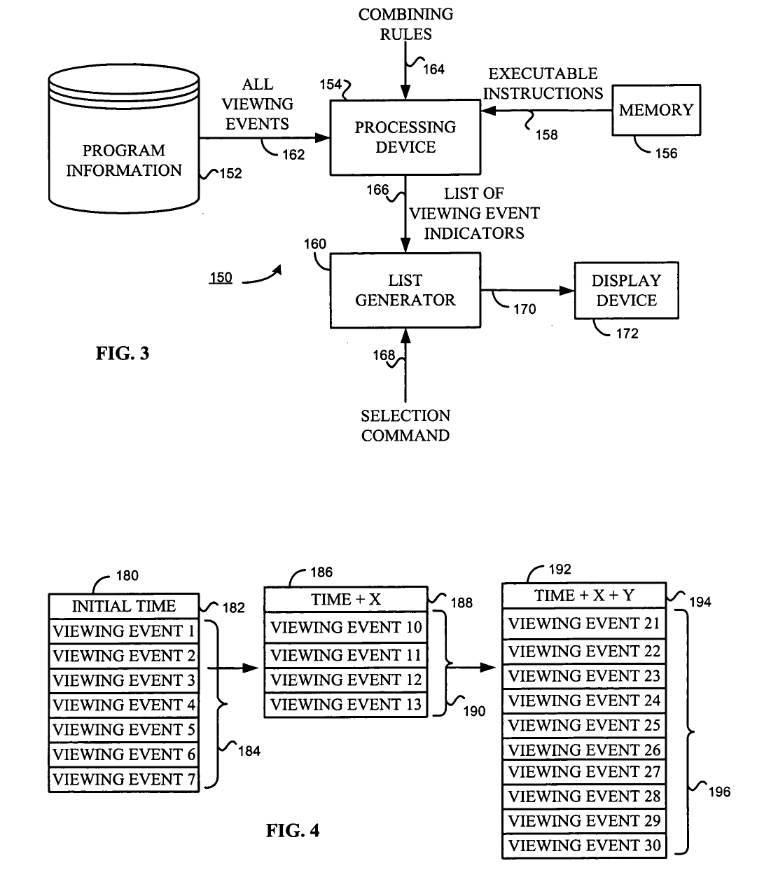

FIG. 3 illustrates a graphical representation of one embodiment of an apparatus 150 capable of the display of electronic program guide information. The apparatus 150 includes a program information database 152, a processing device 154, a memory 156 capable of storing executable instructions 158, and a list generator 160.

The processing device 154 may provide for data processing operations in response to the executable instructions 158. The device 158 may be disposed within one or more processors or may represent executable operations performed by one or more processors. The elements may be implemented in hardware, software or any other suitable implementation recognized by one having ordinary skill in the art. Any processor may be, but not limited to, a single processor, a plurality of processors, a DSP, a microprocessor, ASIC, state machine, or any other implementation capable of processing and executing software or discrete logic or any suitable combination of hardware, software and/or firmware. The term processor should not be construed to refer exclusively to hardware capable of executing software, and may implicitly include DSP hardware, ROM for storing software, RAM, and any other volatile or non-volatile storage medium. Moreover, the database of program information 152 and the memory 156 may be, but not limited to, a single memory, a plurality of memory locations, shared memory, CD, DVD, ROM, RAM, EEPROM, optical storage, microcode, or any other non-volatile storage medium capable of storing digital data. Interactivity between elements may be within a single processing environment, such as a stand alone computing device or may be across one or more processing environments such as across multiple computing devices networked, wired or wirelessly, across a wide area network, local area network, internet, intranet or any other suitable network.

A list of all viewing events 162 may be extracted from the program information database 152. The viewing events list 162 may be acquired from the show lineup information from an existing electronic guide database. Although, any other suitable source of program information may be provided to populate the program information database 152 such that viewing events information 162 may be retrieved therefrom. The processing device 154 further receives combining rules 164. The combining rules 164 may be retrieved from a database or stored within a processing element wherein the combining rules 164 are determined in response to user input or any other suitable determination of rules for combining the program information and thereupon determine specific viewing events in response to user defined parameters.

The processing device 154, in response to the executable instructions 158, receives the viewing event indicators 162 from the program information database 152. The processing device 154 may then generate the first list of viewing event indicators based on a viewing start time of each of a plurality of viewing event indicators. A viewing start time may be interactively received from a user attempting to determine viewing events at a particular time or may be automatically retrieved from the processing device based on an overall system time, such as the current time.

The processing device 154 in response to the executable instructions 158 thereupon generates a second list of viewing event indicators from the first list of viewing event indicators by combining each of the viewing event indicators having common elements. For example, common elements may be, but not limited to, a common identifier such as the common identifier associated with show lineup information within the existing electronic program guide information, a common title, such as the actual title of the viewing event or a description of the title, such as a genre based generalization of the viewing event.

The second list of viewing event indicators 166 is then provided to the list generator 160. The list generator 160 may be implemented in hardware, software or any combination thereof to receive a selection command 168 and generate a video output signal 170 including the second list to a display device 172. The display device 172 may be any suitable display device such as a television monitor, computer screen, a projection screen, an LCD monitor, CRT monitor or any other suitable display as recognized by one having ordinary skill in the art.

In one embodiment, the selection command 168 may be any suitable input command allowing for user interactivity for updating output lists 170 from the list generator 160. For example, the selection command may be a command to select one of the listed viewing events from the list 170 on the display device 172. The selection command 168 may be received from any suitable input source, such as a keyboard, navigational menu, cursor, remote control, or any other suitable input source recognized by one having ordinary skill in the art. Thereupon, the list generator 160 may update the list to expand the associated viewing events, as described below in FIG. 5. In another embodiment, the selection command 168 may be a command to select a particular viewing event such that the list generator 160 may thereupon generate another list of viewing events in another time interval, as illustrated in FIG. 4 below.

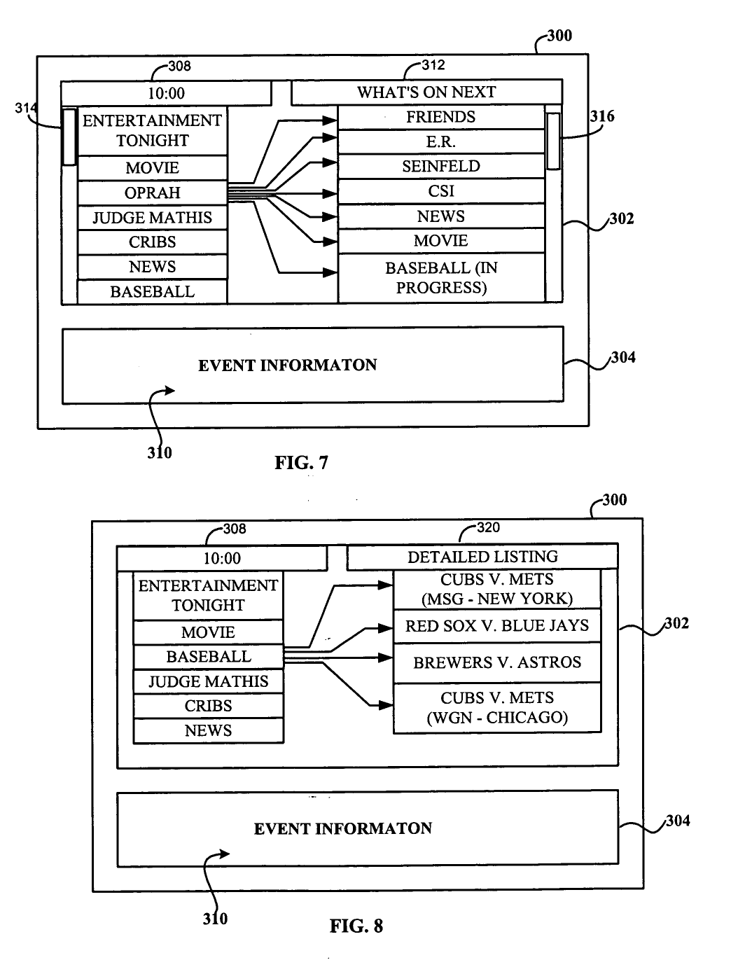

In one embodiment, the output lists 170 including the proper viewing event indicators may displaying on a first portion of the display screen. Viewing event information associated with the viewing event indicator, wherein the viewing event information is the information describing the contents of the particular viewing event, may be displayed on a second potion of the display screen. In this embodiment, the display of the different elements within different screen portions may be in accordance with the co-pending U.S. patent application Ser. No. XX/XXX,XXX entitled “METHOD AND APPARATUS FOR AUTOMATED DISPLAY OF VIDEO PROGRAMMING GUIDE INFORMATION” having a common assignee as the present invention, and as described in further detail below with respect to FIGS. 7 and 8.

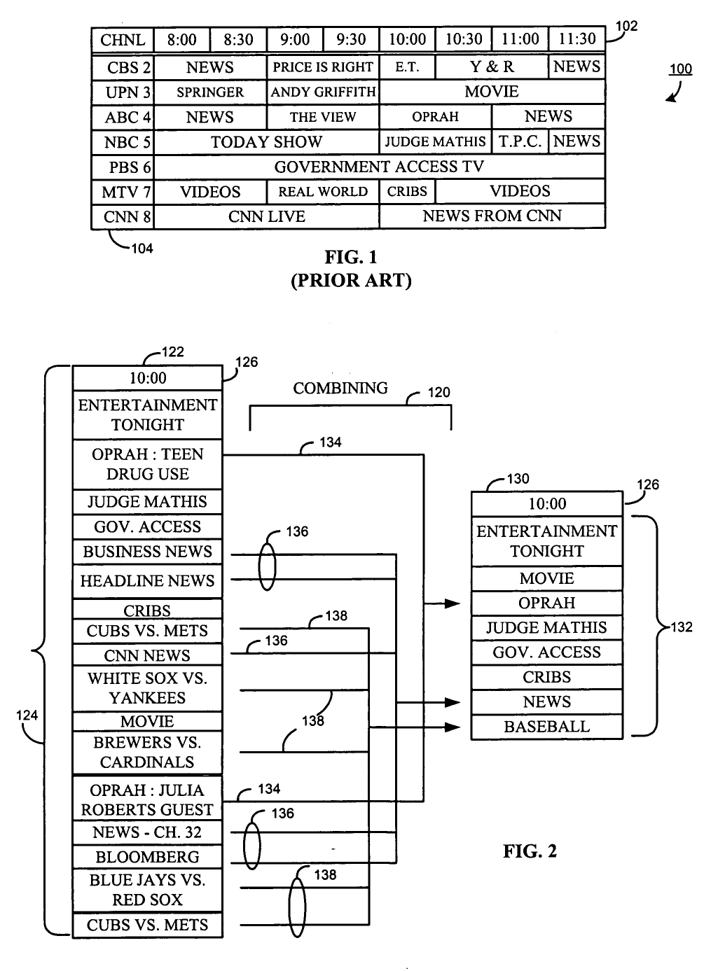

FIG. 4 illustrates a graphical representation of the present invention displaying electronic program guide information at multiple time intervals. A first display of program guide information 180 includes an initial time 182 and multiple viewing event indicators 184. A user may then select a particular viewing event such as to set a reminder, to actively go to a viewing event, setup a recording or any other suitable action therein. Upon selecting the viewing event, the duration of the viewing event itself is determined and a next list 186 of viewing event indicators is generated. The list 186 illustrates a next in time list including the time 188 of the initial time plus some variable x, where x is the duration of the selected viewing event. The list 186 further includes viewing event indicators 190 which are all viewing events that satisfy combining rules, such as the combining rules 164 and have the starting time 188. Therefore, a user is only provided the display of programs that begin upon the completion of the previously selected viewing event. As discussed above, with regards to FIG. 1, prior art grid-based systems overlap programs, contributing to the information overload wherein a user is displayed program information for events that conflict with an already selected viewing event. Therefore, the present invention reduces the information overload by only displaying viewing events having the associated time to which a viewer would seek viewing a particular event. Stated another way, viewing event list 186 includes all of the viewing events satisfying the combining rules 164 and beginning upon the completion of the previously selected viewing events from the list 180.

A user may then, through any interactive capabilities, select one of the viewing events 190 from the list 186 so the present invention generates a third list 192 at a time 194 of the initial time plus the duration of the first selected event plus the duration of the second selected event. The third list 192 includes multiple viewing events 196 once again representing viewing events beginning only upon the completion of the second viewing event. Therefore, a user is subjected to viewing events that are available for watching in its entirety upon the completion of the previous viewing event, thereby reducing the total number of listings of viewing events 196.

In one embodiment, the present invention may further provide for effective viewing management when time-shifted viewing occurs. For example, a personal video recorder (PVR) allowing for time-shifted viewing, e.g. fifteen minutes behind schedule due to pausing of live television, could cause a viewer to miss the beginning of a scheduled event if the scheduled event begins while the viewer is 15 minutes behind the broadcast timing. Therefore, user preferences may be set to force a channel change, automatically start recording the scheduled event, notify the user of pending conflict or any suitable resolution to prevent a viewer from missing a live broadcast based on time-shifted viewing. In one embodiment, the present invention may further allow for the detection of scheduling conflicts between events scheduled to be recorded and upcoming selections. In one embodiment, scheduled recording events may be inserted into the display of viewing events for a particular time, a user may be given a warning screen, automatic preference rules may be generated to resolve the conflict or any other suitable notification and resolution may be utilized, as recognized by one having ordinary skill in the art.

In one embodiment of the present invention, the combining rules 164 may provide for a greater level of flexibility in determining which viewing event indicators are selected for the list of viewing event indicators 166. The combining rules 164 may apply to particular programming types, but the combining rules 164 may also apply to program timing. For example, a combining rule may indicate to include the listing of viewing events based on a particular time wherein the viewing event is already in progress. Therefore, a user may not be precluded from seeing viewing event indicators for events having already started. For example, a sporting event may have begun an hour earlier, but a user may wish to set a combining rule such that the sporting event is always listed until the completion of the event, as a typical baseball television broadcast lasts approximately three hours.

In another embodiment, the combining rules 164 may be set to determine which viewing events make the list of viewing event indicators 166 based on the percentage of the completeness of an event in progress. Using the example of a baseball game, a user may indicate only listing specific events if it is less than 50% of completion. In the baseball genre example, if the broadcast is three hours, after an hour and a half, the listing of the baseball game would be excluded from the list of viewing events, but prior to that hour and a half combining rule, the baseball game would be included on the list of viewing events.

It is also recognized that the combining rules may also filter based on genre types of the viewing events and may also indicate combining based on whether or not a particular event has been previously viewed. For example, if a particular episode is a rerun on prime-time broadcast, the combining rules may exclude that, but if a television program is in syndication, the combining rules may wish to not exclude it because a syndication may already be reruns. It should be understood that any suitable combining rules as recognized by one having ordinary skill in the art may be utilized to further delineate the list of viewing event indicators 166.

Referring back to FIG. 2, a master list of viewing event indicators 122 provide for an almost unmanageable number of viewing event indicators 124. In FIG. 5, the list 130 may be provided to a set of combining rules, such as rules 164 of FIG. 3. In levels of navigation, a user may select a particular event and generate expanded lists. For example, a user selected a viewing event indicator 202, indicating the Oprah Show, this may generate a sub-list 204 which is the expanded listing of available content at that particular time interval. It is also noted that a user may select indicators 206 or 208 to view sub-list 210 and 212 associated with news and baseball, respectively. Further within the sub-list 212, multiple listings of the same events may be provided with viewing event indicators 214 and 216 providing for the same baseball broadcast from different channels. This may also be prevalent in common broadcasts such as a national new events, which are typically carried by multiple broadcast channels and the user may wish to see an initial listing of the actual event but then view a sub-list of all the available broadcast for a particular preferred broadcast station covering the associated event.

FIG. 6 illustrates a flowchart of one embodiment of a method for the display of electronic program guide information. The method begins, step 240, by receiving a plurality of viewing event indicators indicating a plurality of viewing events, step 242. As discussed above, the viewing event indicators are typically data fields including words and/or numbers representing a title or some other indication of particular viewing events such as a television show. The next step is generating a first list of viewing event indicators indicating a viewing start time of each of the plurality of viewing event indicators such that all the of the plurality of viewing event indicators on the first list have the same viewing start time, step 244. As discussed above, a start time may be provided from a user or may be retrieved from system information or may be provided based on a previous viewing selection in combination with the previous viewing selection start time and the duration of the selected item.

Step 246 is generating a second list of viewing event indicators from the first list of viewing event indicators by combining each of the viewing event indicators having common elements. As noted above, the common elements may include a common identifier, a common title, a common genre, or any other suitable commonality such that a user may wish to combine listings in a viewing event list. Next, step 248 is providing the second list to a display device wherein the second list includes a plurality of viewing event indicators. The display device, such as a television display, may thereupon illustrate an on-screen programming guide having the second list of viewing event indicators providing for a reduced number of visible lists. Thereupon, one method of the present invention is complete, step 250.

FIG. 7 illustrates one embodiment of a display 300 with a first screen portion 302 and a second screen portion 304. Within the first screen portion 302 are a plurality of viewing events 308 for a particular time, such as 10 o'clock. It should be noted that FIG. 8 illustrates a representative embodiment of viewing events 308, similar to the viewing events 132 of FIG. 2.

The second screen portion 304 displays event information 310 associated with the particular viewing event 308. For example, the viewing event entitled OPRAH may be selected and information relating to the contents of the episode may displayed in the second screen 304. In this embodiment, the first screen portion further includes a second of viewing event indicators 312, indicating what is on next. The viewing events 312 are chosen based on, among other things, the duration of the selected viewing event 308, which is shown in this exemplary embodiment as being the OPRAH show. If the OPRAH show lasted an hour, this would indicate that the viewing events 312 are viewable at or during 11:00 o'clock. As recognized by one having ordinary skill in the art, if a different viewing event 308 is selected and the selected viewing event has a different running length, the viewing events 312 may be different.

The first viewing events 308 are displayed with a scroll bar 314. Also, the second viewing events 312 are displayed with a scroll bar 316. Therefore, when the list of viewing events 308 and 312 exceed the visible screen portion 302, the lists of viewing events 308 and 312 may be scrolled through.

FIG. 8 illustrates a graphical display of another embodiment of the present invention. The display 300 includes the screen portions 302 and 304 with viewing event 308 listed at a particular time and the display of event invention 310 upon the selection of a particular viewing event 308. When a viewing event 308 is a combined viewing event, such as illustrated in FIG. 2, a second column of viewing events 320 is displayed. This column illustrates a detailed listing of the viewing events 320. In the exemplary embodiment of a viewing event listing a general term BASEBALL, the detailed listing of viewing events 320 includes specific game information and may further include broadcast information. For example, a single game may be broadcasted by different television stations and a viewer can select a preferred broadcast station, such as a local station or preferred announcers. In this embodiment then, the event information 310 may include information associated with a selected viewing event 320 from the detailed listing.

The present invention provides for the display of electronic program guide information through the reduction and efficient assembly of viewing event indicators. Using combining rules and time based display, a user is provided with a list of timely viewing events and is not inundated with the information overload of limitless channel listings and countless time durations. It should be further noted that in one embodiment of the present invention, the listing of viewing event indicators does not include channels. In electronic program guide navigation, the present invention may provide for the actual channel or the associated broadcaster to be irrelevant as the user is primarily interested in content navigation. As such, the present invention allows for the displayed electronic program guide information and the navigation of viewing events based on the contents of the viewing events and regardless of the associated broadcasters.

It should be understood that the implementation of other variations and modifications of the invention in its various aspects will be apparent to those of ordinary skill in the art, and that the invention is not limited by the specific embodiments described herein. For example, the conflict resolution may inquire about multiple conflicts, therefore one embodiment may include allowing an end user to create a priority listing of the conflicting viewing events such that based on system resources, priority levels may automatically determine if a viewing event may be recorded by an associated recording device, the priority level may also dictate quality level of the recording based in conjunction with available system resources. In another example, a time period delta factor may be utilized to determine a range of start times, such as all viewing events beginning ten minutes before and ten minutes after a set time, which include all viewing events having irregular start times. It is therefore contemplated to cover by the present invention, any and all modifications, variations or equivalents that fall within the spirit and scope of the basic underlying principles disclosed and claimed herein.

1. A method for the display of electronic program guide information, the method comprising:
(a) receiving a plurality of viewing event indicators indicating a plurality of viewing events;
(b) generating a first list of viewing event indicators based on a viewing start time of each of the plurality of viewing event indicators such that all of the plurality of viewing event indicators on the first list have the same viewing start time;
(c) generating a second list of viewing event indicators from the first list of viewing event indicators by combining each of the viewing event indicators having common elements; and
(d) providing the second list to a display device, wherein the second list includes a plurality of viewing event indicators.

2. The method of claim 1 further comprising:
prior to step (b), receiving the viewing start time.

3. The method of claim 2 wherein the viewing start time is based on an at least one of: an existing system time and a user input.

4. The method of claim 1 further comprising:
receiving a viewing event selection command, wherein the viewing event selection command selects a selected viewing event indicator from the second list;
calculating a second viewing start time based on the first start time and the duration the viewing event represented by the selected viewing event; and
repeating steps (b) through (d) using the second viewing start time.

5. The method of claim 1 further comprising:
combining the plurality of viewing event indicators based on if the viewing event is in-progress.

6. The method of claim 1 further comprising:
combining the plurality of viewing event indicators based on a percentage of completeness of any of the plurality of viewing events currently in-progress.

7. The method of claim 1 further comprising:
combining the plurality of viewing event indicators based on one or more genre types of the plurality of viewing events.

8. The method of claim 1 further comprising:
combining the plurality of viewing event indicators based on at least one previously viewed indicator.

9. The method of claim 1 wherein the common elements for generating the second list include a common identifier and a common title.

10. An apparatus for the display of electronic program guide information, the apparatus comprising:
a memory device operative to store executable instructions; and
at least one processing device operably coupled to the memory device, the at least one processing device operative to, in response to the executable instructions:
(a) receive a plurality of viewing event indicators;
(b) generate a first list of viewing event indicators based on a viewing start time of each of the plurality of viewing event indicators such that all of the plurality of viewing event indicators on the first list have the same viewing start time;
(c) generate a second list of viewing event indicators from the first list of viewing event indicators by combining each of the viewing event indicators have common elements; and
(d) provide the second list to a display device.

11. The apparatus of claim 10 wherein the processor, further in response to executable instructions:
prior to step (b), receives the viewing start time, wherein the viewing start time is based on at least one of: an existing system time and a user input.

12. The apparatus of claim 10 wherein the processor, further in response to executable instructions:
combines the plurality of viewing event indicators based on if the viewing event is in-progress.

13. The apparatus of claim 10 wherein the processor, further in response to executable instructions:
combines the plurality of viewing event indicators based on a percentage of completeness of any of the plurality of viewing event indicators currently in-progress.

14. The apparatus of claim 10 wherein the processor, further in response to executable instructions:
combines the plurality of viewing event indicators based on one or more genre types of the plurality of viewing event indicators.

15. The apparatus of claim 10 wherein the processor, further in response to executable instructions:
combines the plurality of viewing event indicators based on at least one previously viewed indicator.

16. The apparatus of claim 10 wherein the common elements for the processor to generate the second list include a common identifier and a common title.

17. A method for the display of electronic program guide information, the method comprising:
receiving a plurality of viewing event indicators;
generating a current list of viewing event indicators by:
(a) filtering out viewing event indicators based on a viewing start time;
(b) combining each of the viewing event indicators having a common identifier; and
(c) combining each of the viewing event indicators having a common title;
generating an output signal including the viewing event indicators of the current list;
receiving a viewing event selection indicator such that if the viewing event selection indicator indicates a condensed viewing event:
generating an expanded viewing event list including all combined viewing event indicators.

18. The method of claim 17 further comprising:
displaying the current list of viewing event indicators in a first display screen.

19. The method of claim 18 further comprising:
wherein when the viewing event selection indicator indicates a selected viewing event, displaying viewing event information in a second display screen.

20. The method of claim 18 further comprising:
wherein when the viewing event selection indicator indicates a selected viewing event, repeating steps (a) through (c) to generate an upcoming list using an upcoming start time wherein the upcoming start time is the combination of the viewing start time and the duration of the selected viewing event.

21. The method of claim 18 further comprising:
wherein when the viewing event selection indicator indicates a selected viewing event, determining if the event is to be displayed or recorded.

22. The method of claim 17 further comprising:
the viewing start time is based on at least one of: an existing system time and a user input.

23. The method of claim 17 further comprising:
combining the plurality of viewing event indicators based on at least one of the following: if the viewing event is in-progress, a percentage of completeness of any of the plurality of viewing event indicators currently in-progress, one or more genre types of the plurality of viewing event indicators and at least one previously viewed indicator.

24. A method for the display of electronic program guide information, the method comprising:
generating a current list of viewing event indicators by:
(a) filtering out viewing event indicators based on a viewing start time;
(b) combining each of the viewing event indicators having a common identifier; and
(c) combining each of the viewing event indicators having a common title; and
generating an output signal including only the viewing start time and viewing event indicators of the current list.

25. The method of claim 24 wherein the viewing event indicators of the current lists further include an active link to at least one of: further viewing event indicators if the viewing event indicators have been combined and viewing event information.

26. The method of claim 25 further comprising:
displaying the current list of viewing event indicators in a first display screen;
wherein when the viewing event selection indicator indicates a selected viewing event, displaying viewing event information in a second display screen; and
wherein when the viewing event selection indicator indicates a selected viewing event, displaying viewing event information in a second display screen.
